(19) United States
(12) Patent Application Publication
(10) Pub. No.: US 2008/0319921 A1
(43) Pub. Date: Dec. 25, 2008

(54) Apparatus and method for investment management

(75) Inventor: Mats Anders Stigzelius, London (GB)

Correspondence Address: MORRISON & FOERSTER LLP, 755 PAGE MILL RD, PALO ALTO, CA, 94304-1018, US

(73) Assignee: Apogee ehf, Reykjavik (IS)

(21) Appl. No.: 11/820,863

(22) Filed: Jun. 20, 2007

(51) Int. Cl. G06Q 40/00

(52) U.S. Cl. 705/36 R

(57) ABSTRACT

A method of funding an investment. The method comprises receiving a loan of a first amount from a lender and paying that loan in to an investment fund. The loan is repaid in accordance with a predetermined repayment schedule. The repayment schedule comprises a plurality of repayments made at predetermined regular time intervals.

The present invention is concerned with a method for providing an investment, and more particularly a method for providing a loan used to fund an investment.

Pensions are a major financial consideration in modern society. Individuals are understandably concerned to ensure that they are properly catered for during their retirement.

In the present application some references made to pension schemes operated in specific countries, particularly the United Kingdom and the United States of America. It will however be appreciated that similar pension schemes are operated in other countries.

In many developed countries, until recently, it was the case that a state operated pension scheme would provide a reasonable standard of living in one's retirement. Furthermore, many individuals were members of an employer's pensions scheme providing further retirement income. Some employer's pension schemes were so called defined benefit pension schemes providing a guaranteed income in each year of retirement based upon a percentage of an individual's final salary.

However, recently, changing demographic profiles and increased life expectancy have meant that state pensions are now insufficient to provide a reasonable standard of living during retirement. Furthermore, defined benefit pension schemes of the type described above are increasingly being closed to new entrants and many have significant deficits. That is, such pension schemes have insufficient assets to cover liabilities to pension holders.

In the light of the circumstances set out above, it has become increasingly necessary for individuals to set up their own pension schemes, known as personal pension schemes, to ensure that they are provided with a reasonable pension upon retirement. Such pension schemes typically operate by an employee paying a fixed contribution in to an investment fund each month. An individual's employer may also make contributions to the investment fund. These contributions are appropriately invested in any convenient way. The final amount of the investment fund at retirement is therefore dependent upon contributions made by both the individual and the employer as well as the performance of the investment fund. On retirement, the total investment is typically used to buy an annuity which provides a guaranteed income each year. Some individuals choose to buy an annuity with part of the investment and take the remainder of the fund as a lump sum payment. There are also some annuity products that allow individuals to supplement their existing pension savings arrangements by contributing into a tax deferred annuity product which can then be used to pay out a pension at a later stage.

In some cases, the amount that can be invested in such a pension is limited. For example, currently in the United Kingdom, the maximum which an individual can contribute to their pension in any one year is 100% of their salary. In the United States the limit for pre-tax contributions to a pension under the ‘402(g) limit’ is currently $15,500 in any one year.

As an example, it is to be noted that historically a typical, investment in UK stocks and shares achieves growth of about 7% above inflation. This figure is based upon the average return of the UK stock market since 1918. Similarly, the US stock market has produced a real return of some 6.3% since 1871.

Based on an assumed 7% rate of growth, where an individual enters in to a pension scheme when 25 years old, remains in that pension scheme for 40 years, their salary is $25,000 on entering the scheme, their salary increases by 5% a year and 10% of the salary is invested in an investment fund, the individual can expect the investment fund to have a value of $1.3 million at the age of retirement. Such an investment fund will buy an annuity of around $83,000 at current annuity rates. The annuity guarantees that level of income to an individual for the remainder of their life.

There is currently an accepted desire to increase pension provision. However, existing schemes are limited in the ways this can be achieved. Typically, increased pension provision can be achieved by people working for a longer period of time, paying more tax so as to provide a better state pension, or alternatively investing a larger proportion of their income in a personal pension. None of these possibilities is uniformly considered to be desirable.

In addition to pensions, various other financial services products are also known. For example, it is known to use a mortgage to purchase property. This involves a lender providing a loan in a relatively large amount of money, the loan being secured against the property to be purchased.

In alternative situations, an unsecured loan may be provided when the loan is not secured against any specific asset and is based purely on the borrower's agreement to repay the loan to the lender on predetermined terms. Such terms will include a rate of interest to be applied, and details as to timing of payments to be made. Of course, if the agreed terms are breached the lender will have an action for breach of contract.

In the United States, it is possible to borrow though a 401 K loan. This involves a person borrowing money from their own pension and paying that money back. The loan is typically limited to use for certain specific purposes, such as education, medical expenses, or first time house purchase. There are typically limits on the proportion of a pension fund which can be borrowed in this way.

In some countries, for example South Africa, it is known to borrow money to purchase property such that the borrowed money is secured against a pension fund rather than being secured against the property to be purchased. Such arrangement is very similar to a conventional mortgage, differing only in the form of security.

U.S. Pat. No. 5,903,879 describes a financial services product in which a series of payments are made in to a pension fund by a lender in return for a single lump sum repayment to the lender when the pension fund is redeemed. This means that an individual does not need to deduct pension contributions from their salary, but rather such contributions are obtained from a loan, the loan being repaid from the resulting pension.

It is an object of the present invention to obviate or mitigate at least some of the problems set out above.

According to the present invention there is provided, a method and apparatus for providing an investment. More particularly, there is provided a method and apparatus for funding an investment intended to provide a pension. The method comprises receiving a loan of a first amount from a lender. The loan is paid in to an investment fund. The loan is repaid in accordance with a predetermined repayment schedule, and the repayment schedule comprises the making of a plurality of repayments at predetermined regular time intervals.

The loan is preferably secured against at least part of the funds held in the investment fund. Therefore, if there is a failure to meet the predetermined repayment schedule, the lender may obtain title to at least part of the funds held in the investment fund.

The loan and investment fund may be administered by a single financial services provider or alternatively may be administered by two different financial services providers.

The method may further comprise insuring the loan against an insured event such that occurrence of the insured event causes repayment of at least part of the loan.

The investment fund may have an associated maturity date, for example a date at which a pension becomes payable. The repayment schedule may define a plurality of repayments at times between a first time and a second time. The first time may be a time at which said loan is paid in to said investment fund and the second time may be the maturity date.

The loan may have an associated end date, and any outstanding balance of the loan at the end date may be paid from funds held in the investment fund.

The method may further comprise calculating the first amount from a plurality of parameters. Such parameters may comprise a number of repayments and an amount of each of the repayments. The repayments may be defined as a proportion of an individual's salary. The first amount may be calculated such that the repayments cause the first amount and an associated interest amount to be repaid by said predetermined plurality of repayments. Alternatively, the first amount may be calculated such that the repayments cause interest applied to said first amount to be repaid by said predetermined plurality of repayments.

The first amount may be calculated taking in to account an individual's current salary and predicted increases in that salary. An individual may receive a further loan of a second amount from the lender. The second amount may be paid in to the investment fund. The further loan may be obtained following and based upon an increase in the individual's salary.

In some embodiments of the invention there is provided a method of brokering an investment comprising brokering a loan of a first amount from a lender, arranging that said loan be paid into an investment fund, and arranging that said loan be repaid in accordance with a predetermined repayment schedule, said repayment schedule comprising making a plurality of repayments at predetermined regular time intervals.

To alternative embodiments of the invention there is provided, a method of providing funding for an investment, comprising providing a loan of a first amount to a borrower, receiving from said borrower an undertaking to pay said loan into an investment fund, agreeing that said loan be repaid in accordance with a predetermined repayment schedule, said repayment schedule comprising making a plurality of repayments at predetermined regular time intervals.

The invention also provides a method for managing a loan, the method comprises providing a loan of a first amount to a borrower, said loan intended to be paid in to a investment fund, and receiving an undertaking to provide security over said investment fund. Title of funds in the investment fund may be obtained if the borrower fails to make payments in accordance with a predetermined repayment schedule.

It will be appreciated that features described in the context of one aspect of the invention are equally applicable to other aspects of the invention.

It will be appreciated that embodiments of the present invention can be implemented in any convenient way including by way of suitable methods and apparatus. Additionally, the invention provides a suitably programmed computer and computer network configured to implement embodiments of the invention. Therefore, in addition to provision of a programmed computer, the invention provides a computer readable medium carrying computer readable program code configured to cause a computer or computer network to carry out the method described above.

Embodiments of the present invention will now be described, by way of example, with reference to the accompanying drawings, in which:

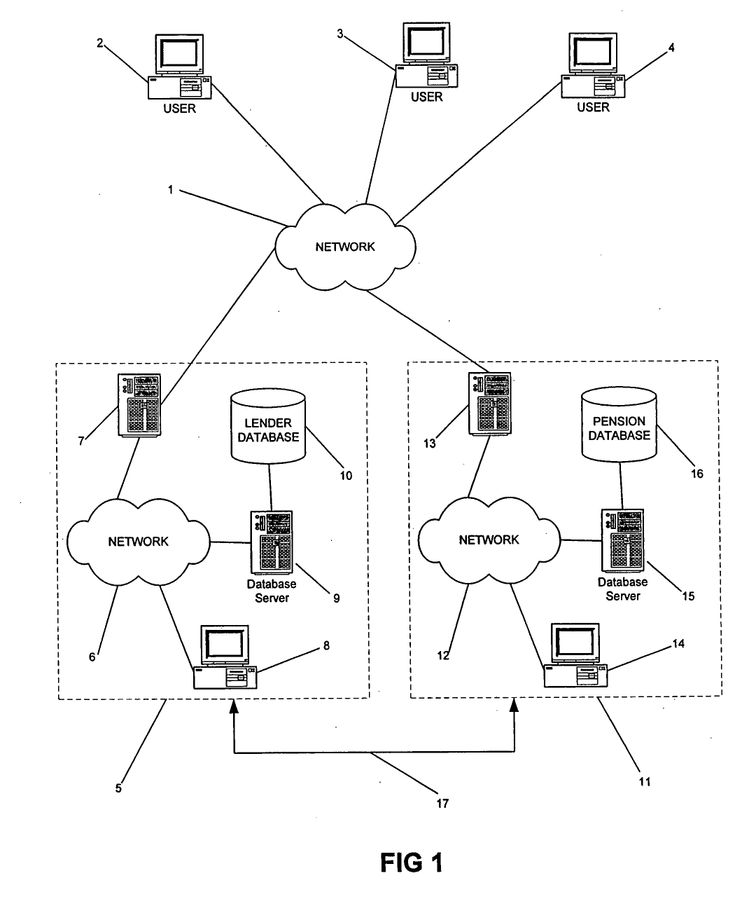

FIG. 1 is a schematic illustration of a computer network on which embodiments of the present invention can be implemented;

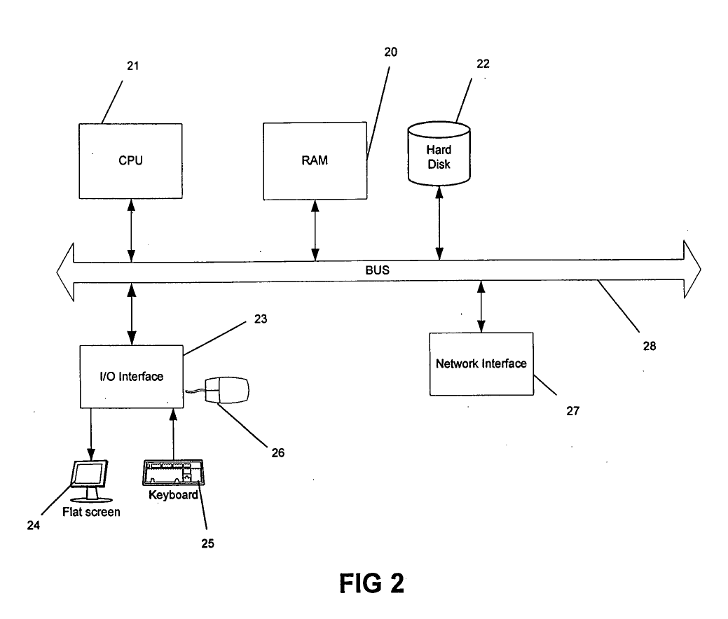

FIG. 2 is a schematic illustration of a computer terminal included in the network of FIG. 1;

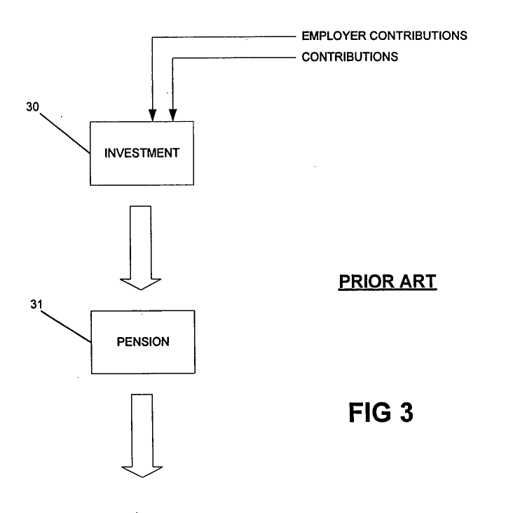

FIG. 3 is a schematic illustration of a prior art pension scheme;

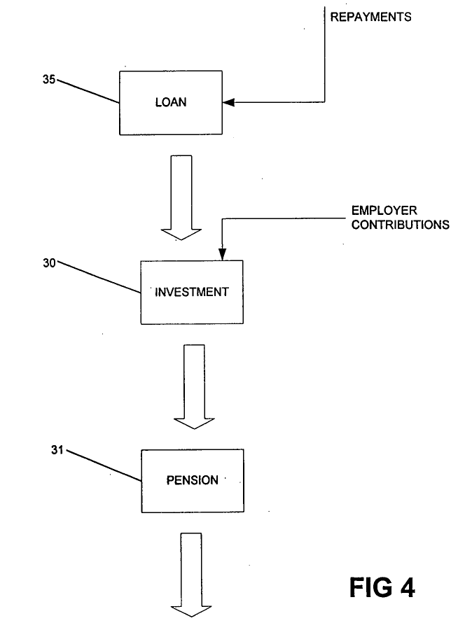

FIG. 4 is a schematic illustration of operation of a pension scheme in accordance with an embodiment of the present invention;

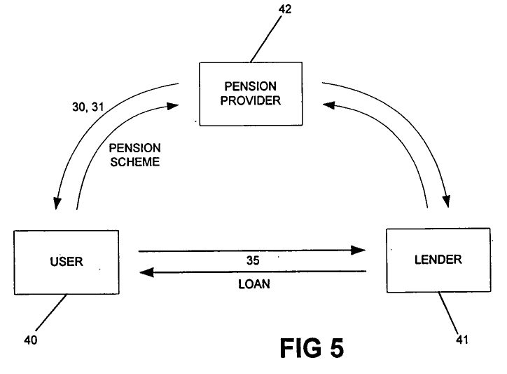

FIG. 5 is a schematic illustration of entities involved in providing a pension scheme in accordance with an embodiment of the present invention;

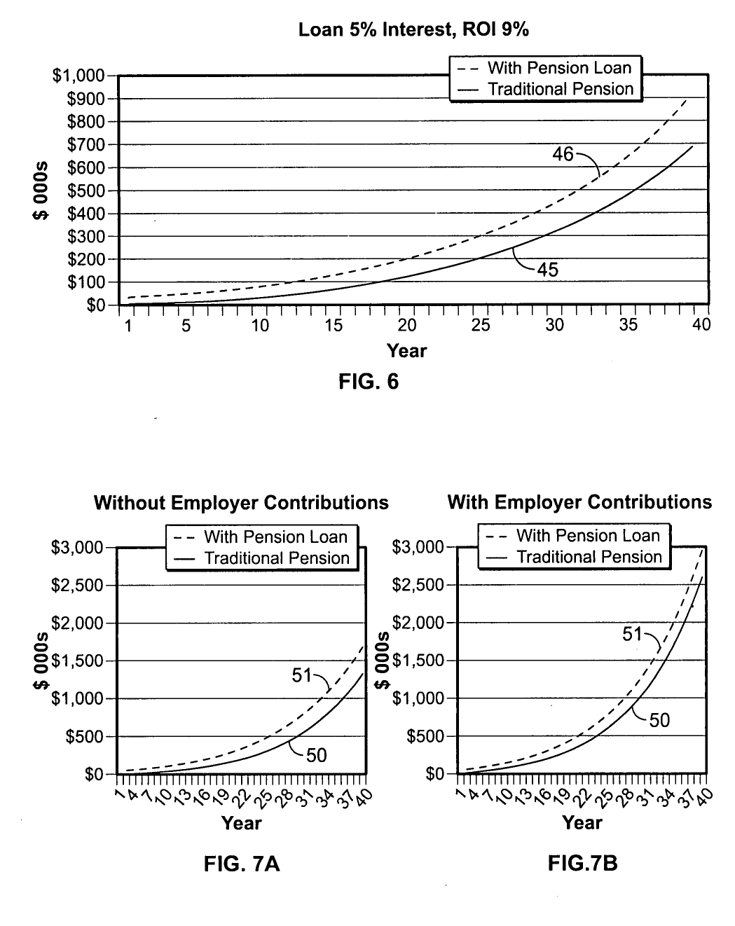

FIGS. 6 to 9B are graphs showing pension performance;

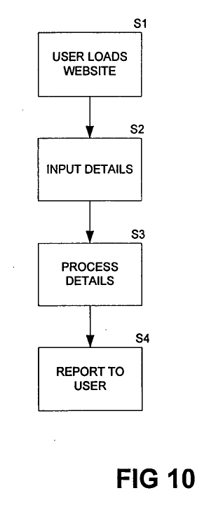

FIG. 10 is a flowchart showing a loan application process;

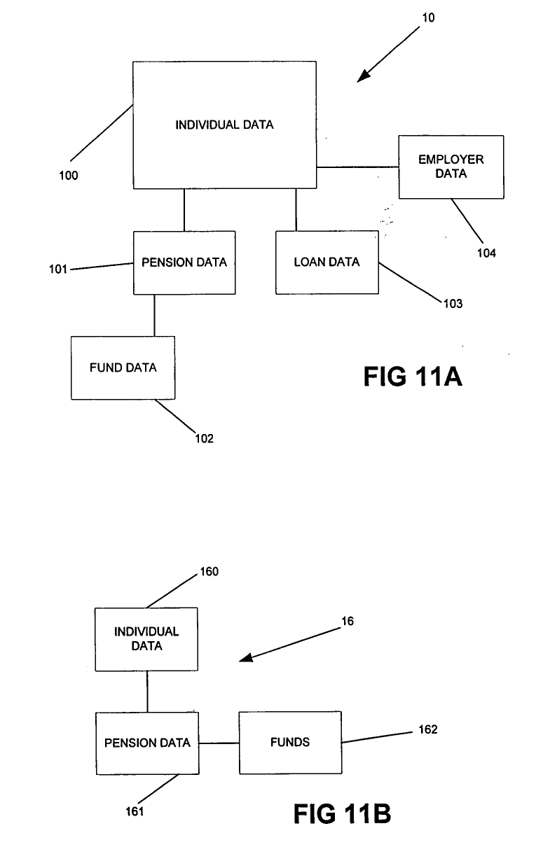

FIGS. 11A and 11B are schematic illustrations of data stored in databases in the network of FIG. 1;

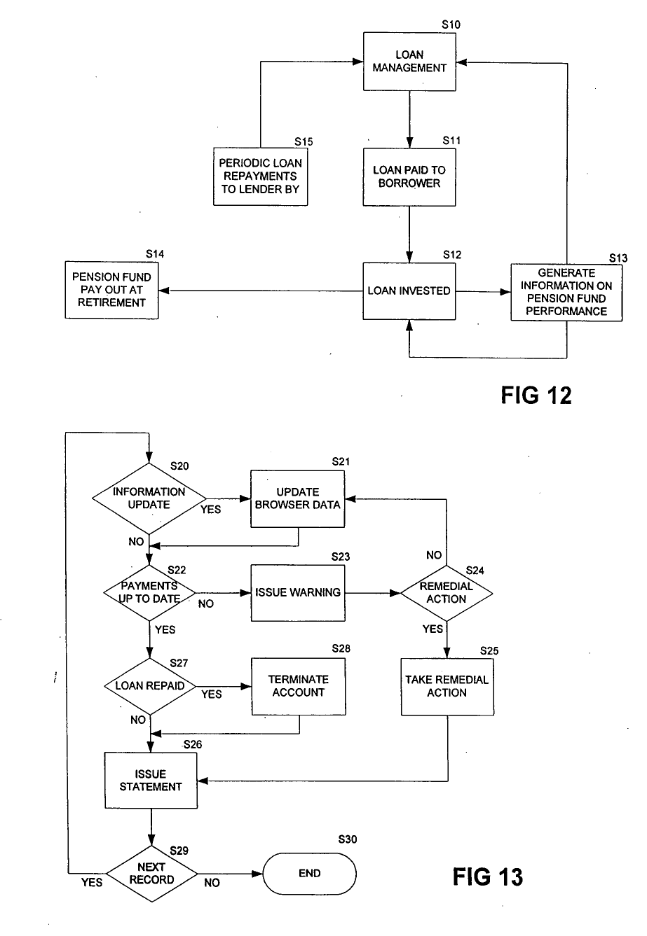

FIG. 12 is a flowchart showing operation of an embodiment of the invention; and

FIG. 13 is a flowchart showing loan management operations carried out in embodiments of the invention.

Referring first to FIG. 1, there is illustrated a network 1 to which a plurality of computing devices are connected. The network 1 can take any suitable form, although in a preferred embodiment of the invention the network 1 is the Internet. A plurality of user terminals 2, 3, 4 are connected to the network 1. The connections between the user terminals 2, 3, 4 and the network 1 can be achieved in any convenient way. For example, where the network 1 is the Internet, the connections can be provided by providing the user terminals 2, 3, 4 with modems such that the user terminals 2, 3, 4 can establish a dialup connection with a remote server (not shown), and the remote server can in turn provide a connection to the network 1. It will be appreciated that in this context reference to dialup connections also includes so called “broadband” connections. Alternatively, the user terminals 2, 3, 4 can be connected to respective local area networks (not shown) and the local area networks can include a server having a connection to the network 1, thereby allowing user terminals 2, 3, 4 to receive data from and transmit data to the network 1.

FIG. 1 also shows a computing environment 5 operated by a financial services provider offering loans. It can be seen that the computing environment 5 includes a network 6. The network 6 has a server 7 connected thereto, the server 7 in turn being connected to the network 1. In this way, the server 7 is able to receive data from the network 6 and transmit that data onto the network 1, and similarly is able to receive data from the network 1 and transmit that data on to the network 6. It can be seen that the computing environment 5 further includes a desktop PC 8 and a database server 9. Both the desktop PC 8 and the database server 9 are connected to the network 6. The database server 9 manages a lender database 10, the structure of which and data stored in which will be described in further detail below.

FIG. 1 also shows a further computing environment 11 operated by a financial services provider providing pension schemes. It can be seen that the computing environment 11 includes a network 12 to which a server 13 is connected. The server 13 is also connected to the network 1. In this way, it will be appreciated that the server 13 can receive data from the network 12 and transmit that data on to the network 1, and similarly receive data from the network 1 and transmit that data on to the network 12. The computing environment 11 further includes a desktop PC 14 and a database server 15. The database server 15 manages a pension database 16. The pension database 16 stores details of pension plans held by various individuals, those individuals perhaps being users of the user terminals 2, 3, 4. Further details of the pension database 16 are provided below.

It can be seen that an arrow 17 illustrates a link between the computing environments 5, 11. This link can be provided in any convenient way. While the link might be a direct point to point link, in preferred embodiments of the invention the link is provided through the network 1, and it will therefore be appreciated that the arrow 17 is merely schematic and is shown to aid understanding.

The user terminals 2, 3, 4 and the desktop PCs 8, 14 can take any convenient form. That is, although the user terminals 2, 3, 4 shown in the form of desktop computers in FIG. 1, it will be appreciated that they can take the form of any suitable computing device, including a laptop computer or a handheld computing device such as a mobile phone or Personal Digital Assistant. Indeed, any computing device having appropriate network connectivity can be used as one of the user terminals 2, 3, 4.

FIG. 2 illustrates an example architecture for one of the computing devices 2, 3, 4, where that computing device takes the form of a desktop PC. It can be seen that volatile storage in the form of Random Access Memory (RAM) 20 is provided. The RAM is configured to store instructions and data on which those instructions operate. A CPU 21 is configured to read instructions from the RAM 20 and execute those instructions, as well as to fetch appropriate data from the RAM 20. Non-volatile storage in the form of a hard disk drive 22 is also provided. An input/output device (I/O) interface 23 is further provided. Appropriate peripheral input and output devices are connectable to the I/O interface. In the schematic illustration of FIG. 2, it can be seen that an output device in the form of a flat screen monitor 24 is connected to the I/O interface 23. Similarly, input devices in the form of a keyboard 25 and a mouse 26 are connected to the I/O interface 23. A network interface 27 is also provided. The network interface 27 can take any convenient form and can specifically be a wired or wireless network interface. The network interface 27 allows the computing device to connect to an appropriate network. It can be seen that the RAM 20, the CPU 21, the hard disk drive 22, the I/O interface 23 and the network interface 27 are connected together by a communications bus 28 along which data and instructions pass.

From the network shown in FIG. 1, it will be appreciated that the desktop PC 8 is able to access data stored in the lender database 10. Access to this data is controlled by the database server 9. It will similarly be appreciated that the desktop PC 14 is able to access data stored in the pension database 16. Again, access to this data will be controlled by the database server 15. In addition to allowing access to data within the respective computing environments 5, 11, it will be appreciated that the network of FIG. 1 is such as to allow the user terminals 2, 3, 4 to also access data stored in the lender database 10 under the control of the database server 9, and to access data stored in the pension database 16 under control of the database server 15. Additionally, by communicating over the network 6, the network 1, and the network 12, the desktop PC 8 is able to access is able to access data stored in the pension database 16 under the control of the database server 15. Additionally, the desktop PC 14 is able to access data stored in the lender database 10 by appropriate communications over the network 12, the network 1, and the network 6. The database server 9 and the database server 15 may be configured so as to allow different computing devices to have different rights of access to the lender database 10 and the pension database 16.

Having presented, in general terms, an overview of hardware used to implement an embodiment of the invention, operation of the invention is described in further detail.

Referring now to FIG. 3, a schematic illustration of a prior art pension scheme is shown. Specifically, an individual wishing to establish a pension pays contributions into an investment fund 30 at predetermined intervals. Such contributions may, for example, be deducted from an individual's salary and paid into the investment fund 30. In addition to those contributions, an individual's employer may similarly make contributions to the investment fund 30. It is intended that the investment fund 30 causes the contributions to accrue and grow. For example, the investment fund 30 may invest contributions in stocks and shares and consequently as prices of those stocks and shares increase, the value of the investment fund 30 similarly increases. Typically, contributions are paid in to the investment fund 30 for a predefined period of time typically corresponding to an individual's working life. At the end of this period, the resulting investment provides a pension 31. Typically, this pension can be used to purchase an annuity, that is a financial services product providing an annual income for each year of the individual's life. In some cases, part of the pension 31 is used to provide the individual with a lump sum of money upon retirement which can be used in any convenient way.

Having described a prior art pension scheme with reference to FIG. 3, FIG. 4 is a high level schematic illustration of an embodiment of the present invention. Here, it can be seen that an individual takes out a loan 35. This loan is paid into the investment fund 30. The investment fund 30 in turn provides a pension 31 as described above. Instead of making regular payments in to the investment fund 30, the individual instead makes loan repayments. The individual's employer cart make contributions to the investment fund 30 in the manner described above.

The loan 35 is provided by an appropriate financial services provider. The loan has an appropriate rate of interest. The loan has a predetermined term, and loan repayments are calculated such that repayments made at predetermined intervals over the predetermined term will cause the loan amount and interest payable to be repaid.

FIG. 5 is a schematic illustration showing relationships required to allow the embodiment of FIG. 4 to operate. Specifically, an individual 40 takes out the loan 35 from a lender 41. The individual 40 additionally establishes a relationship with a pension provider 42 and invests the loan 35 in an investment fund provided by the pension provider 42, thus creating a pension. As will be described in further detail below, it is preferred that a relationship exists between the lender 41 and the pension provider 42, to allow exchange of relevant information.

Although for the purposes of description the lender 41 and pension provider 42 are described as separate entities, it will be appreciated that in some embodiments of the invention a single financial services provider will provide the loan 35 and the investment fund 30 generating the pension 31.

Having described an embodiment of invention in general terms, the embodiment is now described in further detail.

As indicated above, an individual borrows a lump sum by way of a loan 35, and pays that loan in to an investment fund 30. Whereas in the prior art pension scheme described above, a plurality of payments are made in to an investment fund over a predetermined period of time at predetermined intervals, in the described embodiment of the present invention, a lump sum is paid in to the investment fund 30 and the provider of the loan receives regular payments to cover both the loan amount and interest. The individual obtains a benefit from this scheme on the basis that the lump sum paid in to the investment fund 30 is likely, in the long term, to out perform the cost of borrowing meaning that the pension 31 provided when the individual retires will exceed that provided by a prior art pension in to which regular contributions are made.

The loan is preferably secured against the pension fund. Additionally, the individual enters in to an agreement with the provider of the loan to make regular repayments which replace the pension contributions which the individual would usually make.

The amount of the loan available to a particular individual is based on typical lending criteria's such as loan interest rate, current animal earnings, intended repayments, and loan term. The interest rate to be applied to the loan can be specified in any convenient way. For example, a fixed interest rate may be used, or alternatively a variable interest rate defined with reference to a base rate may be used. Indeed, the interest rate can be defined in any convenient way. The repayments can similarly be defined in any convenient way. For example, they may be defined as a percentage of the individual's earnings.

The factors set out above are used to determine a net present value (NPV) of a future income stream for the lender. The NPV is used to determine the loan amount available to an individual. The loan amount can be based either on a fixed salary (e.g. $30,000 for the whole duration of the loan) or alternatively can include assumptions about future salary increases. Examples of the calculation of NPV for the loan 35 are now provided.

The example is based upon a twenty five year old individual earning $25,000 a year. The individual wishes to contribute 10% of their income to provide the pension 31. They intend to make contributions towards the pension 31 for a period of 40 years. Thus, it can be seen that the individual contributes $2,500 of their income towards their pension each year for 40 years.

As indicated above, it is necessary for the lender of the loan 35 to calculate a NPV from the repayments. When calculating the NPV the interest rate must of course also be taken in to account. The calculation determines how much can be borrowed such that the repayments to be made cover the loan amount and interest. Developing the example set out above, a series of 40 payments of $2,500 each are made and a fixed interest rate of 5% is applied. The net present value is determined according to equation 1:

$$N P V = {\sum }_{t = 1}^{t = n} \frac{{C}_{t}}{{( 1 + r )}^{t}} \qquad ( 1 )$$

where:

n is the number of years over which repayments are made;

r is the interest rate; and

Cₜ is the cash flow for each repayment year.

Cₜ can be calculated according to the equation (2):

Cₜ=IY (2)

where:

I is the annual income; and

Y is the percentage of that income to be put towards repayments.

From equations (1) and (2) set out above, developing the example set out above, where an individual has an annual salary of $25,000 a year and pays 10% of that salary in to a pension scheme, and the rate of interest to be applied to the loan is 5%, the net present value is computed by:

$$N P V = {\sum }_{t = 1}^{t = 40} \frac{25 , 000 \times 10 \%}{{( 1 + 0.05 )}^{t}} \qquad ( 3 )$$

### That is:

NPV=$42,898 (4)

From the above it can be seen that at an annual interest rate of 5%, a loan of $42,898 will be paid back over a 40 year period by paying $2,500 each year.

In alternative embodiments of the invention, the value of the loan may be based upon an initial salary together with assumptions about salary increases. That is, C, may be defined by equation (5):

Cₜ=IₜY (5)

where:

Iₜ is the income in year t.

Iₜ is given by equation (6);

Iₜ=Iₜ₋₁+Iₜ₋₁U (6)

### Where:

U is the assumed rate at which salary increases each year; and

Iₒ is the initial, salary.

In such a case, it will be appreciated that contributions made will increase over the period of the loan. Similarly, it will be appreciated that the initial lump sum is larger, providing a larger pension 31.

In preferred embodiments of the invention, the NPV of the loan is calculated based upon a current salary without any assumption of salary increases. Should such salary increases apply, the individual can apply for a further loan 35 based upon the increase.

In some countries, legislation limits maximum pension contributions made in any given year. For example, the maximum contribution in any given year may be 100% of the individual's salary. That is, in the example set out above the individual would only be able to invest $25,000 in the investment fund 30 in any single year. Thus, it would not be possible to invest the total loan set out above in a single year.

In such a case, the loan amount is still computed as set out above. However, given the limit imposed by the legislation only a loan of $25,000 is taken. However, in a second year the individual applies for a further loan. It may be that the individual's salary has increased by this time. For example, if the salary has increased by 5% by year two, the NPV generated by equation (1), will be $45,025, bearing in mind that the loan term will now be 39 years. This NPV is based on the figures quoted above for salary in the first two years, and an assumption of constant salary thereafter. In such a case given that a loan of $25,000 was taken in year one, a further loan of $20,025 is provided in the second year.

In some embodiments of the invention, repayments are applied only to cover interest, with the loan amount being repaid at maturity (e.g. at the end of the 40 year term). In some jurisdictions (for example the United Kingdom) when an individual retires it is possible to redeem a tax free lump sum up to 25% of the value of the pension. This lump sum could be used to pay the loan amount. Such embodiments of the invention are advantageous in that lower contributions can be made during the life of the loan, or the same contributions can be used to obtain a larger loan. Thus, although the risk to the lender is increased the individual is able to borrow a larger sum of money.

Specifically, developing the example set out above if an individual makes repayments of $2,500 a year and an interest rate of 5% is applied, a $50,000 loan could be provided if the repayments are only to cover interest charges. The loan amount of $50,000 would then be repaid at maturity.

It will be appreciated that the investment fund 30 can take any suitable form. It is of course advantageous that performance of the investment fund 30 increases fund value at a greater rate than the rate of interest applied to the loan. For example, the investment fund may increase in value by 7% each year, or 9% where inflation is taken in to account. If a fund management charge of 1% is applied at the start of each year, in a first year where a sum of $42,898 is invested in the investment fund, the fund will increase in value by $3,822 (i.e. 9% less adjustment for asset management charges). In a second year, the amount of $46,291 invested in the fund will increase by $4,125 on the same basis. Continuing this pattern for the term of the loan and investment (assumed to be 40 years in the example) the pension 31 provided will have a value of $901,367. It will recalled that this will involve the individual making repayments of the loan 35 at a rate of $2,500 a year.

If equivalent contributions where paid in to the investment fund 30 (for example as in the prior art pension scheme shown in FIG. 3) and the investment fund was to grow at the same rate, the pension 31 provided would have a value of $682,521. This is shown in FIG. 6 which is a graph in which performance of a traditional pension is depicted by a line 45, while performance of a pension in accordance with the invention is depicted by a line 46.

Thus, it can be seen that the use of the loan 35 allows the pension 31 to have a higher value.

FIG. 7a is a graph showing how the investment fund 30 grows over a 40 year term in an alternative embodiment of the invention. A line 50 shows performance of a traditional pension scheme in to which 10% of an individual's income is paid. The graph is based on an annual return of investment of 9%. A line 51 shows performance of a pension scheme in accordance with the invention in which a loan is provided which is invested in the pension scheme. When the individual receives a salary increase, a further loan is obtained and invested in the investment fund 30. Thus, loan repayments increase in line with salary. It can be seen that the line 51 has a consistently higher value than the line 50 indicating that a pension in accordance with the invention provides better performance. FIG. 7b is a graph showing similar conditions, although here in addition to contributions made by the individual, contributions are made by the individual's employer.

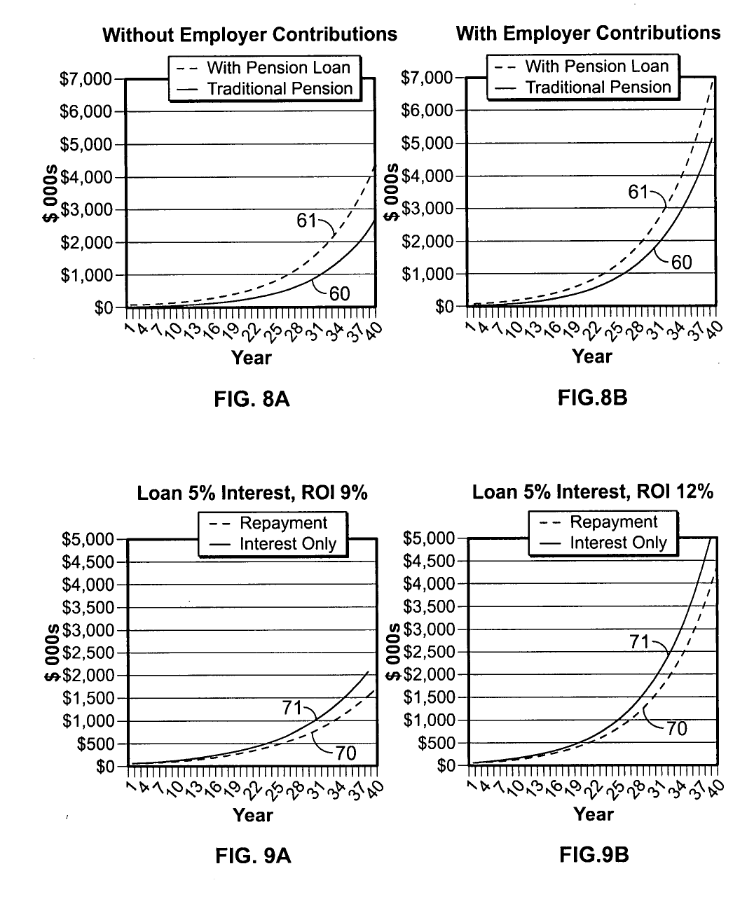

FIGS. 8A and 8B are graphs similar to those of FIGS. 7A and 7B but here it is assumed that the interest rate applied to the loan is 5% while the investment fund grows at a rate of 12%. The graphs of FIGS. 8A and 8B are again based upon an individual entering in to a pension plan when 25 years old and earning a salary $25,000. It is assumed that 10% of the income is paid in to the pension each year and that the salary increases by 5% each year. The initial pension loan is based on the initial salary. However, salary increases each year, a further loan is provided based upon the salary increase as described above.

It is to be noted that FIG. 8A shows a situation in which an individuals employer does not make contributions to the pension while FIG. 8B shows a scenario in which the individuals employer does make contributions to the pension. In the scenario illustrated in FIG. 8A it can be seen that a conventional pension scheme would result in an investment fund of $2.6 million at retirement. However, by taking out an initial loan (and further loans when salary increases) as described above the investment fund has a value of $4.27 million. That is, by employing a loan the investment fund has a value of 164% of that of the conventional investment fund.

With reference to FIG. 8B, where the individual's employer does make contributions to the pension fund, it can be seen that conventionally a pension of $5.21 million would be provided, while by using the loan scheme provided by the invention a pension fund of $6.87 million is achieved. That is, a pension fund has a value of 132% of that of the conventional pension scheme.

It has been described above that repayments made by an individual may be intended only to cover interest payable on the loan and not the loan amount. FIGS. 9A and 9B show performance of a pension while regular payments are made only to cover interest on the loan.

FIG. 9A shows the position under a low (9%) growth scenario while FIG. 9B shows the position under a high (12%) growth scenario. In each of FIGS. 9A and 9B, a line 70 indicates performance of an embodiment of the invention in which repayments are made to cover both the loan and interest payable on that loan while a line 71 represents performance when repayments are made only to cover interest. With reference to FIG. 9A it can be seen that where repayments cover only interest the fund has a value of $1.91 million while where payments cover both interest and the loan amount the pension fund has a value of $1.65 million.

As indicated above, the loan 35 is preferably secured on the investment fund 30, and the individual further undertakes to make regular agreed repayments to the lender of the loan. Preferably, the lender is provided with security over part of the investment fund 30 sufficient to cover the outstanding balance of the loan 35.

As indicated above, with reference to FIG. 5 the pension provider 42 and lender 41 may be a single financial institution. It is likely that the lender 41 will insist that the loan 35 is invested in an approved investment fund 30.

The individual may take out an insurance policy to cover repayments of the loan 35. In such a case, should an insured event occur, repayments of the loan 35 will be met by an insurer. Insured events may include, for example, death of the individual in which case the pension 31 would be secured for the individual's dependents. Alternatively, the insured event may comprise the individual falling ill.

The loan 35 may be transferred from the lender 41 to any other financial institutions should the lender and other financial institution wish to enter in to such a transaction.

Having described embodiments of the invention, implementation of the invention using a network such as that shown in FIG. 1 is now described in further detail. FIG. 10 is a flowchart of processing undertaken when a user intends to establish a pension scheme such as that shown in FIG. 4. Specifically, the flowchart of FIG. 10 shows processing carried out to provide an individual who wishes to establish a pension with a loan 35. To obtain such a loan, the individual uses one of the user terminals 2, 3, 4 to access the network 1. Specifically, the appropriate user terminal runs web browser software to access a website provided by an appropriate web server at step S1 of FIG. 10. The webpage provides a form in to which the individual enters appropriate personal details at step S2, which details are processed at step S3 to determine whether a loan can be provided to the individual and if so in what amount. The outcome of the processing of step S3 is reported to the individual at step S4.

The details input at step S2 of FIG. 10 can take any suitable form. Typically, such details will include personal details such as name, address and date of birth information. The input information will also include employment details such as employer name, employer address and job title. Further details input at step S2 are likely to include details of the individual's salary, details of intended loan repayments, perhaps expressed as a percentage of the salary, and details of an intended retirement age.

The processing of step S3 can take any convenient form. However, typically, the processing will include a credit reference check in which personal details provided at step S2 are used to carry out a lookup operation in a database held by an appropriate organisation, the database including data indicating an individual's credit worthiness. So called credit scoring processes may be carried out and these may include scoring based on profession and/or age. The processing of step S3 will further determine an amount of loan which can be offered to the individual, and such processing is typically based upon equation (1) set out above. It will be appreciated that processing of the type set out in equation (1) will require determination of an interest rate. The interest rate can be determined in any convenient way. For example, in some cases, the interest rate may be fixed, although more preferably the interest rate is determined with reference to details input at step S2.

With reference to step S4, the outcome from the processing of step S3 is reported to the user in any convenient way. Preferably, the result of the processing is reported in real time by providing a webpage to the user. In alternative embodiments, however, the outcome of the processing may be reported by subsequently transmitting the result to the user either by way of email, or conventional mail. If the information reported at step S4 indicates that no loan is available to the individual, no further processing is carried out. If however, it is indicated that a loan is available further processing can either be carried out by using the network of FIG. 1 and more particularly by presenting appropriate webpages. Alternatively further processing can be carried out using a paper based process. For example, an application form may be displayed to the individual which is subsequently printed, signed, and returned to the lender by conventional mail. It will be appreciated that in such cases, it is preferred that the user terminals 2, 3, 4 are provided with an appropriate printing device such as an ink jet or laser printer.

It was described with reference to FIG. 1 that a pension provider operates a pension database, while a loan provider operates a lender database 10. FIG. 11A shows the lender database 10 in further detail. This database is preferably implemented in the form of a relational database comprising a plurality of tables between which relationships are defined. It can be seen from FIG. 11A that the lender database 10 includes an individual data table 100 storing personal information relating to an individual. That is each record will relate to an individual for which data is stored and include personal details such as name, address and date of birth information. Details of an individual's pension are stored in a pension data table 101. It will be recalled that the loan can be secured on an investment fund associated with the pension and accordingly the lender database 10 stores details of the pension fund in a pension data table 101. The pension data table 101 includes a single record for each individual for which data is stored and that record identifies a record of the individual data table 100. Each record in the pension data table 101 includes an account number, a value of the fund, and reference to appropriate fund information. That reference is to a fund data table 102 storing details of a plurality of pension funds together with details of their associated providers.

The lender database 10 further comprises a loan data table 103 storing details of loans. Each record of the loan data table 103 represents a loan and will identify a record of the individual data table 100. Each record of the loan data table 103 comprises an account number, details of an amount outstanding, details of a monthly payment amount, details of payment history, details of an interest rate, details of an initial loan amount, details of loan term, and details of security. Records of the loan data table 103 additionally comprise a notes field in to which free text notes can be entered and fields in to which data files representing scanned documents can also be stored.

The lender database 10 further comprises an employer data table 104 storing data relating to employers. Each record of the employer data table 104 represents a single employer and records of the individual data table 100 identify a record of the employer data table 104 thereby allowing data representing an individuals employer to be stored.

FIG. 11B shows the pension database 16 of FIG. 1 in further detail. It can be seen that this database stores an individual data table 160, a pension data table 161, and a funds table 162. That is, the pension database stores data which is very similar to that stored in part of the lender database 10, given that the pension provider does not need detailed information relating to an individuals loan.

It was indicated above that both the pension and loan may be provided by a single financial services provider. In such a case, a single database may be maintained. Even where the loan and pension are provided by different providers it should be noted that a single database may be used, or alternatively links between the lender database 10 and pension data 16 are preferably provided so as to allow automatic update of appropriate data thereby ensuring consistency.

Referring to FIG. 12, the loan provided in embodiments of the invention is described in further detail.

At step S10 loan management operations are carried out. Such operations include loan approval operations described above with reference to FIG. 10. Assuming that the loan is approved, the loan is paid to the individual at step S11, and invested in an appropriate investment fund at step S12. The investment fund is appropriately managed causing generation of information on fund performance at step S13. This information is used to further manage the investment fund and is also fed back to the loan management operations carried out at step S10. That is, the lender is likely to require information on fund performance so as to monitor that it has adequate security for the borrowed amount.

At the predetermined retirement age, the pension is paid at step S14.

At step S15, the individual makes a predetermined loan repayments, such payments are input in to the loan management function of step S10.

The flowchart of FIG. 12 shows operation of an embodiment of the invention in which a loan is invested in the investment fund. As described above, in alternative embodiments of the invention contributions made by an individual's employer are also paid in to the investment fund.

The loan management operation of step 110 comprise two basic operations. A fast operation is concerned with obtaining approval for a particular loan and has been described with reference to FIG. 10. However, on going loan management is now described with reference to FIG. 13. Such loan management is carried out on a regular basis. At step S20 a check is carried out to determine whether information has been updated. If this is the case, an appropriate update in the appropriate database is carried out at step S21. Having carried out such an update, processing continues at steep S22. If information has not been updated processing passes directly from step S20 to S22. At step S22 a check is carried out to determine whether payments are up to date. In the event that payments are not up to date a warning is issued to an individual at step S23. Such a warning can be issued in any convenient way, including by way of a letter, an email or a telephone call. At step S24 a check is carried out to determine whether remedial action is to be taken. Such action is usually triggered by payments being overdue for either more than a predetermined time period or alternatively in an amount greater than a predetermined amount. If no remedial action is to be taken, processing passes from step S24 to step S21 where borrower data is updated to indicate the warning at step S23. If however remedial action is required, processing passes from step S24 to S25 where remedial action is taken. Such remedial action can either include the initiation of legal proceedings or alternatively taking over security in the pension fund. Where remedial action is taken, a statement is preferably issued to the individual at step S26.

If the check of step S22 determines that payments are up to date processing passes to step S27 where a check is carried out to see whether the loan has been repaid. If this is the case, the account is terminated at step S28 and processing continues at step S26. The processing described above is preferably carried out for each individuals loan record in turn. Accordingly, a check at step S29 determines whether further records remain to be processed. If this is the case, processing returns to step S20. Alternatively, processing ends at step S30.

Investments described above have been such that payments are made to an investment fund and that investment fund is used to purchase an annuity. It should be noted, that in alternative embodiments of the invention, the loan described above is invested directly in an annuity. This annuity then subsequently provides an annual income based upon the terms of the annuity. It should be noted that such an arrangement is sometimes preferable. Specifically, in the United States, the amount which can be invested in an investment fund intended to provide a pension in any one year is currently limited to $15,500. However, no such limits apply to the purchase of annuities. Given that tax on annuity based investments is deferred until funds are withdrawn from the annuity, it will be appreciated that there are considerable benefits to the use of annuities in this way.

It should further be noted that in general terms, funds placed in an investment fund intended to provide a pension can be taken from an individual's pre tax or post tax income. Similarly, repayments of the loan described above can similarly be derived from pre tax or post tax income.

Having described embodiments of the invention in detail, it will be appreciated that various modifications can be made to the described embodiments without departing from the spirit and scope of the present invention as defined by the appended claims.

1. A method of funding at investment, comprising:
receiving a loan of a first amount from a lender, the loan being intended by the lender to be paid in to an investment fund;
paying said loan into an investment fund;
repaying said loan in accordance with a predetermined repayment schedule, said repayment schedule comprising making a plurality of repayments at predetermined regular time intervals.

2. A method according to claim 1, wherein said investment fund is arranged to provide a pension.

3. A method according to claim 1, wherein said loan is secured against at least part of funds held in said investment fund.

4. A method according to claim 1, wherein said loan and said investment fund are administered by a single financial services provider.

5. A method according to claim 1, wherein said loan and said investment fund are administered by different financial services providers.

6. A method according to claim 1, further comprising insuring said loan against an insured event such that occurrence of said insured event causes repayment of at least part of said loan.

7. A method according to claim 1, wherein said investment fund has an associated maturity date, and said repayment schedule defines a plurality of repayments at times between a first time and a second time, wherein said first time is a time at which said loan is paid into said investment fund and said second time is said maturity date.

8. A method according to claim 1, wherein said loan has an associated end date, and any outstanding balance of said loan at said end date is paid from funds held in said investment fund.

9. A method according to claim 1, further comprising calculating said first amount from a plurality of parameters.

10. A method according to claim 9, wherein said plurality of parameters comprise a number of repayments and an amount of each of said repayments.

11. A method according to claim 10, wherein said repayments are defined as a proportion of an individual's salary.

12. A method according to claim 10, wherein said first amount is calculated such that said repayments cause said first amount and an associated interest amount to be repaid by said predetermined plurality of repayments.

13. A method according to claim 10, wherein said first amount is calculated such that said repayments cause interest applied to said first amount to be repaid by said predetermined plurality of repayments.

14. A method according to claim 1, wherein said first amount is calculated with reference to an individual's current salary and predicted increases in said salary.

15. A method according to claim 1, further comprising:
receiving a further loan of a second amount from said lender; and
paying said second amount into said investment fund.

16. A method according to claim 15, wherein said further loan is obtained following and based upon an increase in an individual's salary.

17. A computer readable medium carrying computer readable instructions configured to cause a computer to carry out a method according to any preceding claim.

18. A computer apparatus configured to manage investment funding, the apparatus comprising:
a memory storing processor readable instructions; and
a processor configured to read and execute instructions stored in said memory;
wherein said instructions comprise instructions causing said processor to carry out a method according to any one of claims 1 to 16.

19. A method of brokering an investment comprising:
brokering a loan of a first amount from a lender, the loan being intended by the lender to be paid in to an investment fund;
arranging that said loan be paid into an investment fund;
arranging that said loan be repaid in accordance with a predetermined repayment schedule, said repayment schedule comprising making a plurality of repayments at predetermined regular time intervals.

20. A computer readable medium carrying computer readable instructions configured to cause a computer to carry out a method according to claim 19.

21. A computer apparatus configured to broker an investment, the apparatus comprising:
a memory storing processor readable instructions; and
a processor configured to read and execute instructions stored in said memory;
wherein said instructions comprise instructions causing said processor to carry out a method according to claim 19.

22. A method of providing funding for an investment, comprising:
providing a loan of a first amount to a borrower from a lender, the loan being intended by the lender to be paid in to an investment fund;
receiving from said borrower an undertaking to pay said loan into an investment fund;
agreeing that said loan be repaid in accordance with a predetermined repayment schedule, said repayment schedule comprising making a plurality of repayments at predetermined regular time intervals.

23. A method according to claim 19, further comprising:
receiving from said borrower a charge over at least part of said investment fund.

24. A computer readable medium carrying computer/readable instructions configured to cause a computer to carry out a method according to claim 22 or 23.

25. A computer apparatus configured to manage investment funding, the apparatus comprising:
a memory storing processor readable instructions; and
a processor configured to read and execute instructions stored in said memory;
wherein said instructions comprise instructions causing said processor to carry out a method according to claim 22 or 23.

26. A method for managing a loan, the method comprising:
providing a loan of a first amount to a borrower, said loan being intended to be paid into an investment fund; and
receiving an undertaking to provide security over said investment fund.

27. A computer readable medium carrying computer readable instructions configured to cause a computer to carry out a method according to claim 26.

28. A computer apparatus configured to manage investment funding, the apparatus comprising:
a memory storing processor readable instructions; and
a processor configured to read and execute instructions stored in said memory;
wherein said instructions comprise instructions causing said processor to carry out a method according to claim 26.
